(19) United States
(12) Patent Application Publication
(10) Pub. No.: US 2012/0258209 A1
(43) Pub. Date: Oct. 11, 2012

(54) ASEPTICALLY PACKAGED NUTRITIONAL CONCENTRATE

(75) Inventors: David C. Ulstad, Dublin, OH (US); Terrence B. Mazer, New Albany, OH (US); Wilson George Zeitler, Westerville, OH (US)

(73) Assignee: ABBOTT LABORATORIES, Abbott Park, IL (US)

(21) Appl. No.: 13/440,610

(22) Filed: Apr. 5, 2012

Related U.S. Application Data
(60) Provisional application No. 61/472,911, filed on Apr. 7, 2011.

(30) Foreign Application Priority Data
Apr. 26, 2011 (CA) 2737972

(51) Int. Cl. A23C 9/154; B65B 55/14; A23L 2/38

(52) U.S. Cl. 426/106; 426/590; 426/399; 426/506; 426/580

(57) ABSTRACT

Disclosed are packaged compositions comprising an aseptically sterilized container and a sterilized, concentrated, nutritional liquid emulsion that is aseptically packaged and sealed within the container. Also disclosed are methods for making and using the packaged compositions. In some embodiments, the aseptically packaged, concentrated, nutritional liquid emulsions have a desirable flavor and aroma and have increased emulsion stability.

This application claims the benefit of U.S. Provisional Application No. 61/472,911 filed Apr. 7, 2011, and Canadian Patent Application No. 2,737,972, filed Apr. 26, 2011, the disclosures of which are incorporated by reference in their entireties.

### FIELD OF THE DISCLOSURE

The disclosure relates to aseptically packaged compositions comprising concentrated, nutritional liquid emulsions, and to methods for making such compositions.

### BACKGROUND OF THE DISCLOSURE

There are many different types of packaged nutritional liquids suitable for oral administration to humans, which compositions typically comprise various combinations of fat, protein, carbohydrates, vitamins and minerals. These liquids are often manufactured and packaged as aqueous emulsions so as to provide a product matrix that will accommodate a variety of water soluble and insoluble nutrients.

During the manufacturing process, these packaged nutritional liquid emulsions are sterilized to reduce microbial contaminants to the extent necessary to render the emulsions suitable for oral administration to humans. These processes often include thermal processes such as retort sterilization and aseptic process sterilization. A typical retort process involves introducing the nutritional emulsion into a suitable container, sealing the container, and then heating the sealed container and its contents for a time period and at temperature sufficient for sterilization. An aseptic sterilization process on the other hand typically involves separately sterilizing the interior of a food grade container and a nutritional emulsion and then combining the sterilized container and the sterilized nutritional emulsion in a clean room environment and sealing the container with a previously sterilized closure (e.g., foil or screw cap) prior to leaving that sterile environment.

Aseptic sterilization processes for sterilizing nutritional liquid emulsions have grown in popularity over the years. By using such processes, nutritional liquid emulsions do not have to be held as long at a high process temperature as required for retort sterilization. These reduced process times are generally preferred as they result in a decreased amount of product oxidation as compared to longer process cook duration. Additionally, aseptic sterilization of plastic containers is generally preferred over retort sterilization of plastic containers as retort sterilization requires high temperature heating of the plastic container which can result in failure of the plastic container during sterilization.

Although aseptically processed nutritional liquid emulsions have become more popular of late, it brings with it some limitations. Aseptic processing is most typically used for small single use packages and is not used as readily for larger volume emulsions, especially when those emulsions are formulated as concentrated liquids having a relatively high solids content. These concentrated liquid emulsions are diluted with water or other aqueous liquid prior to use and are preferred by many consumers as an economical alternative to ready to feed liquids. Consumers like concentrated liquid emulsions because they reduce the bulk of product that must be carried home and the products are often less expensive per serving than similar ready to use products.

There is therefore a need for concentrated, nutritional liquid emulsions, especially large volume concentrated liquid emulsions, effectively packaged and processed without subjection to the harsh conditions and temperatures of retort processing.

### SUMMARY OF THE DISCLOSURE

One embodiment of the disclosure includes an aseptically packaged composition for infants including an aseptically sterilized container and at least 236 ml of a sterilized, concentrated, nutritional liquid emulsion that is aseptically packaged within the container.

Another embodiment includes a method of making an aseptically packaged, concentrated, nutritional liquid emulsion for an infant, including the steps of sterilizing a concentrated, nutritional liquid emulsion, sterilizing a container, and aseptically packaging at least 236 ml of the sterilized emulsion into the sterilized container to form an aseptically packaged, concentrated, nutritional liquid emulsion.

Another embodiment includes a method of making a liquid nutritional beverage suitable for oral administration to an infant. The method includes the steps of: obtaining at least 236 ml of an aseptically packaged, concentrated, nutritional liquid emulsion having a caloric density of from about 1.2 to about 4.0 kcal per ml; decanting a portion of the concentrated, nutritional liquid emulsion into a container; and diluting the portion with an aqueous liquid to reduce the caloric density by at least 40%, to form a liquid nutritional beverage for oral administration to the infant.

It has been found that concentrated, nutritional liquid emulsions, which are suitable for oral administration following dilution with an aqueous liquid, may be aseptically processed and packaged in relatively large volumes exceeding about 236 ml. It has been found that these large volume concentrates have desirable aesthetics and are surprisingly much more stable than other large volume concentrates that have been retort process and packaged. This improvement in large volume emulsion stability was not observed with ready to feed formulas.

### DETAILED DESCRIPTION

The aseptically packaged compositions of the present disclosure may comprise an aseptically sterilized container and select volumes of a sterilized, concentrated, nutritional liquid emulsion that is aseptically packaged within the container. The essential features of the packaged compositions as well as some of the many optional variations are described in detail hereinafter.

The term “nutritional” as used herein, unless otherwise specified, means a composition suitable for oral administration that comprises one or more of fat, protein and carbohydrate.

The term “concentrate” and “emulsion concentrate” are used interchangeably herein and, unless otherwise specified, refers to a nutritional liquid that is in the form of an aqueous emulsion that may be combined with a diluting liquid such as water, milk (including human or animal milk), or other aqueous liquid to form a beverage. The term “concentrate” does not indicate or imply a specific concentration or density, but instead merely refers to a comestible liquid that is concentrated relative to the resulting beverage that is formed after the concentrate is combined with a diluting liquid.

The term “liquid nutritional beverage” as used herein, unless otherwise specified, means formulations that are intended for direct consumption (usually within 24-48 hours of mixing or opening). In many cases, such beverages are capable of meeting the primary or sole nutritional needs of an infant to which the referenced nutritional formulation is directed. It is understood, however, that such nutritional formulations can optionally be used as a dietary supplement and not as a primary or sole nutritional source. Liquid nutritional beverages comprise at least one of fat, protein, and carbohydrate, and are suitable for oral administration to a human.

The term “emulsion” as used herein, unless otherwise specified, refers to aqueous emulsions, including water-in-oil, oil-in-water, and complex emulsions, but most typically oil-in-water emulsions.

The term “plastic” as used herein, unless otherwise specified, means food grade plastics approved by the U.S. Food and Drug Administration or other suitable regulatory group, some non-limiting examples of which include polystyrene, polyethylene terephthalate, high density polyethylene, polypropylenes, polycarbonates, and so forth. Plastics may also be laminated or co-extruded and comprise more than one type of plastic. Additionally, plastics may also include barrier material layers, adhesive layers, colorants, and other additives, etc.

The terms “sterile,” “sterilized,” or “sterilization” as used herein, unless otherwise specified, refers to the reduction in transmissible agents such as fungi, bacteria, viruses, spore forms, and so forth, in food or on food grade surfaces to the extent necessary to render such foods suitable for human consumption. Sterilization processes may include various techniques involving the application of heat (e.g., steam heating), hydrogen peroxide, peracetic acid, and or other chemicals, irradiation, high pressure, filtration, or combinations or variations thereof.

The term “retort packaging” and “retort sterilizing” are used interchangeably herein, and unless otherwise specified, refer to the common practice of filling a container, most typically a metal can or other similar package, with a nutritional liquid and then subjecting the liquid-filled package to the necessary heat sterilization step, to form a sterilized, retort packaged, nutritional product.

The term “aseptic packaging” as used herein, unless otherwise specified, refers to the manufacture of a packaged product without reliance upon the above-described retort packaging step, wherein the nutritional emulsion and package are sterilized separately prior to filling, and then are combined under sterilized or aseptic processing conditions to form a sterilized, aseptically packaged, nutritional emulsion.

The term “solids content” as used herein, unless otherwise specified, refers to all the components of the emulsion apart from the water, regardless of whether these other components are in fact solids or liquid.

All percentages, parts and ratios as used herein, are by weight of the total composition, unless otherwise specified. All such weights as they pertain to listed ingredients are based on the active level, and therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made. The articles “a” and “an” are used herein to refer to one or to more than one (i.e., to at least one) of the grammatical object of the article. By way of example, “an element” means one element or more than one element.

All combinations of method or process steps as used herein can be performed in any order, unless otherwise specified or clearly implied to the contrary by the context in which the referenced combination is made.

The various embodiments of the concentrated, nutritional liquid emulsions of the present disclosure may also be substantially free of any optional or selected essential ingredient or feature described herein, provided that the remaining concentrated, nutritional liquid emulsion still contains all of the required ingredients or features as described herein. In this context, and unless otherwise specified, the term “substantially free” means that the selected concentrated, nutritional liquid emulsion contains less than a functional amount of the optional ingredient, typically less than 0.5% by weight, including less than 0.1% by weight, and also including zero percent by weight, of such optional or selected essential ingredient.

The concentrated, nutritional liquid emulsions and corresponding manufacturing methods of the present disclosure can comprise, consist of, or consist essentially of the essential elements and features of the disclosure as described herein, as well as any additional or optional ingredients, features, or elements described herein or otherwise useful in nutritional applications.

The section headings used herein are for organizational purposes only and are not to be construed as limiting the described subject matter in any way. It will be appreciated that there is an implied “about” prior to metrics such as temperatures, concentrations, and times discussed in the present teachings, such that slight and insubstantial deviations are within the scope of the present teachings herein. In this application, the use of the singular includes the plural unless specifically stated otherwise.

### Package

The nutritional liquids of the present disclosure are packaged into a container, all or a majority by weight of which may be plastic, metal, glass, paper, cardboard, a package comprising a combination of such materials such as a can with a plastic body and a metal cap, lid, rim, or other minor packaging component. In various embodiments, the container comprises laminated materials, such as multilayer plastics, thermoformed laminated plastic materials, and or paper/plastic/foil laminates used to make Tetra boxes.

In various embodiments, the container comprises from about 50% to 100% by weight of a plastic. The plastic container of some embodiments, which may be an extruded plastic container, may be comprised of a single layer of plastic, or may be comprised of two or more layers (multi-layer) of plastic that may or may not have an intermediate layer. One suitable plastic material is high-density polyethylene. A suitable intermediate layer is ethylene vinyl alcohol. In at least one embodiment, the plastic container is a 236 ml multi-layer plastic bottle with a foil seal and a recloseable cap, wherein the multilayer bottle comprises two layers of high density polyethylene with an intermediate layer of ethylene vinyl alcohol. In another embodiment, the plastic container is a 946 ml single or multi-layer plastic bottle with a foil seal and a recloseable cap.

The plastic container or package used with the nutritional compositions described herein are generally sized and configured to limit to the greatest extent possible the amount of headspace present therein. Because oxygen located in the air in the headspace can cause unwanted oxidation of various components of the nutritional composition, it is generally preferred to limit the headspace, and hence the amount of oxygen present in the plastic package. In one embodiment, the plastic package or container includes less than 13 cubic centimeters of headspace. In another embodiment, the plastic package includes less than 10 cubic centimeters of headspace.

Metal, glass, coated or laminated cardboard or paper containers are also well-known in the art and can be suitably selected by one of ordinary skill in the art based on the disclosure herein. These types of containers are generally suitable for use with aseptic sterilization methods and, as such, are suitable for use in the present disclosure.

The container for use herein may include any container suitable for use with liquid nutritional products that is also capable of withstanding aseptic processing conditions (e.g., sterilization) as described herein and known to those of ordinary skill in the art. A suitable container may be a single-dose container, or may be a multi-dose resealable, or recloseable container that may or may not have a sealing member, such as a thin foil sealing member located below the cap. Non-limiting examples of such containers include bags, plastic bottles or containers, pouches, metal cans, glass bottles, juice box-type containers, foil pouches, plastic bags sold in boxes, or any other container meeting the above-described criteria. Preferred are plastic containers, more preferably a resealable multi-dose plastic container, a non-limiting example of which is a 946 ml plastic bottle with a foil seal and a plastic resealable cap. In some embodiments, the container may include a direct seal screw cap. In alternative embodiments, the container may be a flexible pouch having an internal volume of at least 946 ml of the concentrated emulsion.

### Composition

The nutritional liquids in the various embodiments can be characterized as concentrated, nutritional liquid emulsions. The nutritional liquids in the embodiments are produced in the form of an aqueous emulsion that are intended to be combined with a diluting liquid such as water, milk, or other aqueous liquid prior to consumption. Emulsions for use herein are most typically formulated as oil-in-water, water-in-oil, or complex aqueous emulsions, and even more typically as oil-in-water emulsions having a continuous aqueous phase and a discontinuous oil phase. The nutritional liquids may be shelf-stable.

The concentrated, nutritional liquid emulsions for use in the methods and compositions of the embodiments are in liquid or semi-liquid form (preferably liquid form) under ambient conditions. As used herein, the term concentrated, nutritional liquid emulsion specifically excludes solid formulations such as bars, flowable powders or granules, or other non-liquid product forms.

Concentrated, nutritional liquid emulsions for use herein may be defined in terms of their caloric density. The concentrated emulsions are formulated to have a caloric density that, after dilution, is tailored to the nutritional needs of the end user. Accordingly, in most instances, the concentrated, nutritional liquid emulsion has a caloric density of from about 1.1 to about 4.0 kcal per ml, also including from about 1.2 to about 4.0 kcal per ml, also including about 1.3 to about 2.5 kcal per ml, and also including from about 1.4 to about 2.0 kcal per ml.

Concentrated, nutritional liquid emulsions for use herein may also be defined in terms of their solids content. In various embodiments, the concentrated, nutritional liquid emulsion contains from about 1.5 to about 3.5 times the solids content of the nutritional beverage when prepared as directed. In various embodiments, described herein, the concentrated, nutritional liquid emulsion contains about twice the solids of the liquid nutritional beverage. When prepared as directed, the concentrate is diluted in a ratio of about one part concentrated, nutritional liquid emulsion to about one part diluting liquid to achieve a desired liquid nutritional beverage. In most cases, the resulting beverage should be used within 24-72 hours after reconstitution with the diluting liquid.

Other concentrated, nutritional liquid emulsion concentrations are contemplated. In all cases, however, the liquid nutritional beverage is formed by reconstituting or combining the concentrate with water, milk, or other common liquids to any desired concentration of concentrate (e.g., 10% by weight concentrate, 50% by weight concentrate, 66% by weight concentrate, and the like).

Because embodiments contain concentrated, nutritional liquid emulsions, the packaged compositions disclosed herein are distinguishable from nutritional liquids characterized as ready-to-feed (RTF) formulas or ready-to-drink liquids. With RTF formulas or ready-to-drink liquids, the liquids are packaged in liquid form suitable for immediate consumption upon removal from the closed plastic container holding the liquid, without the need for dilution. In contrast, the concentrated, nutritional liquid emulsions for use herein may be inappropriate for immediate consumption, particularly for infants. For example, concentrated, nutritional liquid emulsions having greater than about 0.91 kcal per ml may lead to dehydration in some infants.

The concentrated, nutritional liquid emulsions provide advantages over ready to feed formulas. For example, because the temperature of the diluting liquid may be adjusted independently of the concentrated, nutritional liquid emulsion, the consumer can warm or cool the reconstituted beverage by modifying the temperature of diluting liquid before addition to the concentrated, nutritional liquid emulsion. In this way, the temperature of the concentrated, nutritional liquid emulsion may be adjusted without subjecting the concentrated, nutritional liquid emulsion to harsher heating conditions (e.g., a burner plate or a microwave oven), or time consuming methods such as heating a mixed bottle in a heated water bath.

The nutritional liquid emulsions typically contain up to 95% by weight of water, including from about 50% to 95%, also including from about 60% to about 90%, and also including from about 70% to about 85%, of water by weight of the nutritional liquid.

The nutritional liquid emulsions may have a pH ranging from about 3.5 to about 8, but are most advantageously in a range of from about 4.5 to about 7.5, including from about 5.5 to about 7.3, including from about 6.2 to about 7.2.

Although the serving size for the nutritional liquid emulsion can vary depending upon a number of variables, a typical serving size ranges from about 50 to about 450 ml, including from about 100 to about 250 ml, including from about 150 ml to about 240 ml.

The concentrated, nutritional liquid emulsions are packaged in the container in amounts of at least 236 ml of concentrated, nutritional liquid emulsion, including at least 946 ml, and also including from about 590 ml to about 1,200 ml of concentrated, nutritional liquid emulsion.

The concentrated, nutritional liquid emulsions of the present disclosure comprise at least one of fat, protein, and carbohydrate. Various concentrated, nutritional liquid emulsions of the present disclosure can also contain a source of vitamins and minerals.

Suitable carbohydrates, fats and proteins for use in the compositions and methods of the present disclosure include any of the materials well known to those skilled in the art of making liquid nutritional formulations, including formulations that contain extensively hydrolyzed protein. For suitable protein sources, non-limiting examples include milk, soy, rice, animal or meat, vegetable (e.g., pea, potato), egg (e.g., egg albumen), gelatin, and fish. Non-limiting examples of suitable intact proteins suitable for use in preparing an extensively hydrolyzed protein for use herein include soy based, milk based, casein protein, whey protein, rice protein, beef collagen, pea protein, potato protein, and combinations thereof.

Non-limiting examples of suitable protein hydrolysates for use herein include soy protein hydrolysate, casein protein hydrolysate, whey protein hydrolysate, rice protein hydrolysate, potato protein hydrolysate, fish protein hydrolysate, egg albumen hydrolysate, gelatin protein hydrolysate, combinations of animal and vegetable protein hydrolysates, and combinations thereof. Protein may also be provided in the form of free amino acids.

The concentrated, nutritional liquid emulsion for use herein is preferably supplemented with various free amino acids in order to provide a more nutritionally complete and balanced formula, non-limiting examples of free amino acids of which include L-tryptophan, L-tyrosine, L-cystine, taurine, L-methionine, L-arginine, and L-carnitine.

Extensively hydrolyzed proteins (protein hydrolysates) for use in the methods and compositions of the present disclosure are proteins that have been hydrolyzed and broken down into shorter peptide fragments and amino acids, wherein the resulting degree of hydrolysis is at least 20%, preferably from 20% to about 80%. The term “extensively hydrolyzed” as used herein, means a protein hydrolysate having a minimum degree of hydrolysis of at least 20%, with the preferred ranges being referenced above. In the broadest sense, a protein has been hydrolyzed when one or more amide bonds have been broken. Breaking of amide bonds may occur unintentionally or incidentally during manufacture, for example due to heating or shear, but for purposes of the methods and compositions of the present disclosure, the term “hydrolyzed protein” simply means a protein that has been processed or treated in a manner intended to break amide bonds. Intentional hydrolysis may be affected, for example, by treating an intact protein with enzymes or acids.

The terms “protein hydrolysates” or “hydrolyzed protein” are used interchangeably herein and refer to extensively hydrolyzed proteins, wherein the degree of hydrolysis is at least 20%, preferably from 20% to about 80%, more preferably from about 30% to about 80%, even more preferably from about 40% to about 60%. The degree of hydrolysis is the extent to which peptide bonds are broken by a hydrolysis method. The degree of protein hydrolysis for purposes of characterizing the extensively hydrolyzed protein component of the present disclosure is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, indigestible oligosaccharides such as fructosoligosaccharides (FOS), and combinations thereof.

Examples of fat or lipid materials suitable for use in the compositions and methods of the present disclosure include any lipid that is otherwise suitable for consumption by humans, non-limiting examples of which include coconut oil, soy oil, corn oil, olive oil, safflower oil, high oleic safflower oil, MCT oil (medium chain triglycerides), sunflower oil, high oleic sunflower oil, palm oil, palm olein, canola oil, and combinations thereof.

Other suitable fat materials for use herein include arachidonic acid (ARA), docosahexaenoic acid (DHA), and combinations thereof. These materials have been reported to have beneficial effects in infants, including enhanced brain and vision development. These materials and their benefits are described in U.S. Pat. Nos. 5,492,938; 5,374,657; and 5,550,156 (Kyle et al.) Non-limiting examples of fat sources of arachidonic acid and docosahexaenoic acid include marine oil, egg derived oils, fungal oil and algal oil. Marine oil is available from Mochida International of Tokyo, Japan. Docosahexaenoic acid is available from Martek Biosciences Corporation of Columbia, Md., U.S.A. Arachidonic acid is available from Genzyme Corporation of Cambridge, Mass., U.S.A. and from Martek Biosciences Corporation of Columbia, Md., U.S.A.

The concentrated, nutritional liquid emulsions for use in the methods of the present disclosure preferably include other optional materials, non-limiting examples of which include nucleotides, vitamins, minerals, and combinations thereof. Non-limiting examples of suitable nucleotides include adenosine 5′-monophosphate, cytidine 5′-monophosphate, disodium guanosine 5′-monophosphate, disodium uridine 5′-monophosphate, and combinations thereof. Non-limiting examples of suitable vitamins include Vitamin A, Vitamin E, Vitamin K, thiamine, riboflavin, Vitamin B6, Vitamin B12, niacin, folic acid, pantothenic acid, biotin, choline, inositol, and combinations thereof. Non-limiting examples of suitable minerals include calcium, phosphorus, magnesium iron, zinc, manganese, copper, iodine, selenium, sodium, potassium, chloride, and combinations thereof.

For the various ingredients in the aseptically packaged concentrated, nutritional liquid emulsions herein, the concentration or use of the ingredients, whether essential or optional, should be added at a level or in a manner that renders the resulting product safe and effective for its intended use. For many concentrated, nutritional liquid emulsions, especially infant formulas, the concentration of the reconstituted beverage should ideally adhere to any regional guidelines for the selected formula in the defined user population. For example, in the United States, nutritional guidelines for most infant formulas are set forth in the Infant Formula Act, 21 United States Code (U.S.C.) Section 350(a). It should be understood, however, that the concentration of such ingredients for purposes of defining the various embodiments of the present disclosure can be higher, the same as, or even lower than any regional guidelines, including the above-referenced guidelines, especially in those instances where the recommended ingredient levels are eventually modified.

The concentrated, nutritional liquid emulsion for use herein may further comprise a thickening agent, many suitable examples of which are known in the formulation arts. Non-limiting examples of suitable thickening agents include gum arabic, gum ghatti, gum karaya, gum tragacanth, agar, furcellaran, guar gum, xanthan gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, dextran, carrageenans, and combinations thereof. The selected amount of thickening agent will vary depending upon factors such as the particular stabilizer selected, other ingredients in the formula, and the stability and viscosity of the targeted formula.

Thickening agents such as gums have been found to be especially useful in selected infant formulas to raise viscosity to thus reduce the occurrence of spit-up in some infants. Non-limiting examples of suitable gums for use in this capacity include gum arabic, gum ghatti, gum karaya, gum tragacanth, agar, furcellaran, guar gum, gellan gum, locust bean gum, and combinations thereof. Alternatively, starches such as rice can be used to elevate viscosities. Formula for reducing infant spit-up is described in U.S. Pat. No. 6,099,871 (Martinez), which description is incorporated herein by reference.

Emulsifying agents are also suitable for use in the concentrated, nutritional liquid emulsions of the present disclosure, the selection and use of which is well within the ordinary skill of one in the formulation arts. These skilled artisans will often select and use an emulsifying agent in these concentrated, nutritional liquid emulsions to help provide sufficient stability of the targeted emulsion system, such selection being at least partially dependent upon the other selected ingredients in the system.

### Manufacture

In various embodiments, the aseptically packaged, concentrated, nutritional liquid emulsions for infants may be prepared by the method comprising the steps of: sterilizing a concentrated, nutritional liquid emulsion; sterilizing an open container; and aseptically packaging at least 236 ml of the sterilized emulsion into the sterilized container to form an aseptically packaged, concentrated, nutritional liquid emulsion.

The concentrated, nutritional liquid emulsion of the embodiments may be prepared by any known or otherwise effective manufacturing technique for preparing a concentrated, nutritional liquid emulsion. Many such techniques are known for nutritional liquids and can easily be applied by one of ordinary skill in the art to the concentrated, nutritional liquid emulsions described herein.

The concentrated, nutritional liquid emulsions of the present disclosure can therefore be prepared by any of a variety of known or otherwise effective formulation or manufacturing methods. In a typical process for preparing a concentrated, nutritional liquid emulsion, an initial formula is batched from dry and liquid ingredients. In one suitable manufacturing process, for example, at least three separate slurries are prepared, including a protein-in-fat (PIF) slurry, a carbohydrate-mineral (CHO-MIN) slurry, a protein-in-water (PIW) slurry. The PIF slurry is formed by heating and mixing the oil (e.g., canola oil, corn oil, etc.) and then adding an emulsifier (e.g., lecithin), fat soluble vitamins, and a portion of the total protein (e.g., milk protein concentrate, etc.) with continued heat and agitation. The CHO-MIN slurry is formed by adding with heated agitation to water: minerals (e.g., potassium citrate, dipotassium phosphate, sodium citrate, etc.), trace and ultra trace minerals (TM/UTM premix), thickening or suspending agents (e.g. avicel, gellan, carrageenan). The resulting CHO-MIN slurry is held for 10 minutes with continued heat and agitation before adding additional minerals (e.g., potassium chloride, magnesium carbonate, potassium iodide, etc.), and/or carbohydrates (e.g., HMOs, fructooligosaccharide, sucrose, corn syrup, etc.). The PIW slurry is then formed by mixing with heat and agitation the remaining protein, if any.

The resulting slurries are then blended together with heated agitation and the pH adjusted to 6.6-7.0, after which the composition is subjected to high-temperature short-time (HTST) processing during which the composition is heat treated, emulsified and homogenized, and then allowed to cool. Water soluble vitamins and ascorbic acid are added, the pH is adjusted to the desired range if necessary, flavors are added, and water is added to achieve the desired total solid level. The composition is then aseptically packaged to form an aseptically packaged concentrated, nutritional liquid emulsion.

Other suitable methods for making nutritional products are described, for example, in U.S. Pat. No. 6,365,218 (Borschel, et al.), U.S. Pat. No. 6,589,576 (Borschel, et al.), U.S. Pat. No. 6,306,908 (Carlson, et al.), U.S. Patent Application 20030118703 A1 (Nguyen, et al.), which descriptions are incorporated herein by reference to the extent that they are consistent herewith.

In various embodiments, the resulting aseptically packaged, concentrated, nutritional liquid emulsion has a caloric density from about 1.1 to about 4.0 kcal per ml, also including from about 1.2 to about 4.0 kcal per ml, also including from about 1.2 to about 2.5 kcal per ml, and also including from about 1.3 to about 2.0 kcal per ml. In at least one embodiment, the concentrated, nutritional liquid emulsion comprises a caloric density of about 1.35 kcal per ml. In specific embodiments, the concentrated, nutritional liquid emulsion contains a solids content from about 1.5 to about 3.5 times that of the diluted nutritional beverage prepared as directed. In at least one embodiment, the solids content of the concentrated, nutritional liquid emulsion contains a solids content twice that of the diluted nutritional beverage when prepared as directed.

As discussed above, the nutritional guidelines for infant formulas are set forth in the Infant Formula Act, 21 U.S.C. section 350(a). Most generally, the concentrated, nutritional liquid emulsion will contain a source of protein, carbohydrate, fat, vitamins and minerals.

The container for use in the aseptic packaging step described herein is typically sterilized prior to being filled with its sterilized contents. The container is most typically sterilized by the application of a peroxide or acid, such as hydrogen peroxide, peracetic acid, or other suitable sterilant to the internal surface and or internal wall of the container. The hydrogen peroxide, peracetic acid, or other disinfectant is often applied in an atomized mist. After a disinfectant is applied, the container may be transported along a conveyor system during which time the container may be subjected to one or more sprayings of hot sterilized air, preferably hot, sterilized, dry air. The aseptically prepared container is then aseptically filled with sterilized product. The container may be injected with nitrogen gas after filling to reduce the amount of oxygen in the headspace. The product is sealed, such as hermetically sealed, before exiting the sterilized zone.

A concentrated, nutritional liquid emulsion that is to be packaged aseptically may be prepared in the same or substantially the same way as a product that is to be retort packaged, but for the final packaging preparation sequence. In other words, once a concentrated, nutritional liquid emulsion is formulated, it will only then be treated differently in preparation for the packaging process, depending upon the selection of retort or aseptic packaging. For aseptic packaging, the concentrated, nutritional liquid emulsion may be further heat treated to a temperature of from about 160° F. to about 185° F. as a preheating step, subjected to ultra high temperature treatment in the range of from about 280° to about 300° F. for a period of from about 5 to about 15 seconds, to sufficiently reduce the bioburden to allow the products to maintain safe levels, i.e., commercially sterile, over an extended shelf-life of the finished product, which shelf life may exceed 1 month, including from about 6 months to about 24 months, and also including from about 9 months to 18 months. The treated concentrated, nutritional liquid emulsion is then homogenized at 1000 psi or higher and aseptically packaged.

Suitable aseptic packaging techniques for use herein can include any of the well known aseptic packaging methods disclosed in the formulation arts for preparing liquid nutritional formulas, all of which are generally directed to the sealing or filling of a sterilized liquid into a sterilized, air-tight container. Accordingly, in various embodiments, the concentrated, nutritional liquid emulsion is hermetically sealed within the container. Many variations on the basic method exist and are well known to those of ordinary skill in the formulation art, non-limiting examples of which are described in U.S. Pat. No. 6,096,358 (Murdick et al.); U.S. Pat. No. 6,227,261 (Das et al.); and U.S. Pat. No. 6,371,319 (Yeaton et al.), which descriptions are incorporated herein by reference. Product finishing may optionally include over-capping, labeling, tamper-banding, case-packing, and palletizing.

### Use

When diluted as directed, the sterilized, concentrated, nutritional liquid emulsions described herein are useful to provide supplemental, primary, or sole sources of nutrition, and or to provide infants or other appropriate individuals one or more benefits as described herein. In accordance with such methods, the sterilized, concentrated, nutritional liquid emulsions are diluted as directed and the resulting beverage may be administered orally as needed to provide the desired level of nutrition.

Accordingly, at least one embodiment includes a method of making a liquid nutritional liquid suitable for oral administration to an infant, the method comprising the steps of: obtaining at least 236 ml of an aseptically packaged, concentrated, nutritional liquid emulsion having a caloric density of from about 1.2 to about 4.0 kcal per ml; decanting a portion of the emulsion into a container; and diluting the portion of the emulsion with an aqueous liquid to reduce the caloric density by at least 40%, to form a liquid nutritional beverage suitable for oral administration to an infant.

### EXAMPLES

The following examples illustrate specific embodiments and or features of the aseptically packaged concentrated, nutritional liquid emulsions of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the concentrated, nutritional liquid emulsions, unless otherwise specified.

### Example I

Several concentrated, nutritional liquid emulsions are evaluated for emulsion stability by subjecting each to a high speed centrifugation (31,000×g, 20° C., 8 hours) and then evaluating the relative amounts of the resulting serum, cream layer, and pellet materials produced. The concentrated, nutritional liquid emulsions in this Example I are packaged nutritional emulsions available from Abbott Nutrition, Columbus, Ohio and comprise fat, protein, carbohydrate, vitamins, minerals and water. A listing of the nutritional emulsions and the test results are summarized in the tables below.

The test results show that the layer distribution in the aseptically processed concentrate is similar to that found in each of the ready to feed formulas (both retort and aseptic), which is in stark contrast to the layer distribution in the retort concentrate.

The layer distribution in the aseptically processed concentrate (larger cream layer weight, smaller pellet weight) vs. that in the retort concentrate (low cream layer weight, high pellet weight) is indicative of improved emulsion stability. The larger cream layer is associated with greater protein loading onto the fat, a well established property of stable emulsions. Additionally, it is noted that the cream layer for the Similac® Advance® concentrate (7.1%) is nearly twice the fat content (3.6%), another indication of significant protein loading, also found to be positively correlated with emulsion stability. Finally, the smaller pellet weight is associated with less insoluble material, another property of stable emulsions.

Table II compares the cream layer ratios, aseptic/retort, of RTF or Concentrate Similac® Advance® emulsions. As shown in Table II, the Similac® Advance® concentrate product has a marked improvement in the cream layer ratio between the aseptically processed product as compared with the retort sterilized product (with an aseptic/retort value of 165%). By contrast, the Similac® Advance® RTF product does not show a comparable improvement in the cream layer ratio (with an aseptic/retort value of 100%).

TABLE I
Centrifugation Layer Distribution: Ready
to Feed Concentrated Emulsions

| | Cream Layer, | Serum layer, | Pellet layer, |
|---|---|---|---|
| | g per 100 g of | g per 100 g of | g per 100 g of |
| Product | as fed product | as fed product | as fed product |
| Similac ® Advance ® | 7.8 | 90.7 | 1.5 |
| RTF, retort, | | | |
| 2 oz. bottle | | | |
| Similac ® Advance ® | 7.6 | 90.3 | 2.1 |
| RTF, retort, | (n = 2) | (n = 2) | (n = 2) |
| 8 oz. bottle | | | |
| Similac ® Advance ® | 7.6 ± 0.2 | 90.6 ± 0.2 | 1.8 ± 0.1 |
| aseptic, | (n = 3) | (n = 3) | (n = 3) |
| 32 oz. bottle | | | |
| Similac ® Advance ® | 4.3 | 89.2 | 6.5 |
| Concentrate, retort, | | | |
| 13 oz. can | | | |
| Similac ® Advance ® | 7.1 | 91.4 | 1.5 |
| Concentrate, aseptic, | | | |
| 32 oz. bottle | | | |

TABLE II
Comparison of Cream Layer Ratios, Aseptic % of Retort,
in Ready to Feed and Concentrated Emulsions

| Product | Aseptic | Retort | Aseptic % of Retort |
|---|---|---|---|
| Similac ® Advance ® RTF | 7.64% | 7.62% | 100% |
| Similac ® Advance ® | 7.1% | 4.3% | 165% |
| Concentrate | | | |

As shown in the tables above, among the packaged nutritionals evaluated, only the aseptically packaged, concentrated, nutritional liquid emulsions shows a marked increase in the cream layer ratio relative to its retort packaged version, thus demonstrating improved emulsion stability for aseptically packaged nutritional emulsions when the emulsion is a large volume concentrate.

### Example II

Examples II illustrates an embodiment of concentrated, nutritional liquid emulsion that is aseptically packaged within the container, the ingredients (and amounts per 1000 kg batch) of which are listed in the table below.

| Ingredient Name | Amount per 1000 Kg batch | Kg/g/mg |
|---|---|---|
| Ingredient Water | Q.S | kg |
| Condensed Skim Milk | 166.6 | kg |
| Lactose | 106.1 | kg |
| High Oleic Safflower Oil | 27.16 | kg |
| Soybean Oil | 20.42 | kg |
| Coconut Oil | 19.48 | kg |
| GOS | 16.71 | kg |
| Whey Protein Concentrate | 12.20 | kg |
| Calcium Carbonate | 1.072 | kg |
| Ascorbic Acid | 958.6 | g |
| Potassium Citrate | 894.5 | g |
| Monoglycerides | 690.0 | g |
| Soy Lecithin | 690.0 | g |
| ARA Oil | 684.2 | g |
| Potassium Hydroxide | 659.8 | g |
| Nucleotide/Chloride Premix | 568.9 | g |
| Potassium Chloride | 480.8 | g |
| Vit/Min/Taur Premix | 276.9 | g |
| DHA Oil | 256.1 | g |
| Carrageenan | 200.0 | g |
| Magnesium Chloride | 174.7 | g |
| Ferrous Sulfate | 112.7 | g |
| Choline Chloride | 104.8 | g |
| Vitamin A, D3, E, K1 Premix | 86.90 | g |
| Citric Acid (Processing Aid) | 64.55 | g |
| Mixed Carotenoid Premix | 45.63 | g |
| L-Carnitine | 6.371 | g |
| Riboflavin | 2.921 | g |
| Vitamin A Palmitate | 1.504 | g |
| Sodium Chloride | as needed | |
| Tricalcium Phosphate | as needed | |
| Potassium Phosphate Monobasic | as needed | |

The concentrated, nutritional liquid emulsion is prepared as described above. Briefly, slurries are prepared, including a protein-in-fat (PIF) slurry, a carbohydrate-mineral (CHO-MIN) slurry, and a protein-in-water (PIW) slurry. The resulting slurries are then blended together with agitation and the pH adjusted to 6.6-7.0, after which the composition is subjected to emulsification followed by heat treatment with a ultra high-temperature short-time (UHTST) process, cooled to 165-185° F. followed by a high-temperature short-time (HTST) process, homogenized, and finally cooled to 33-40° F. Once the emulsion is initially blended, heat treated, and homogenized and cooled, it is stored in finished product (FP) tanks where ascorbic acid is added, the pH is adjusted to the desired range if necessary, and water is added to achieve a solids content twice that of the beverage when prepared as directed.

From the FP tanks, the emulsion goes to a high pressure pump that pushes it through the heat exchanger of the aseptic processor. In the aseptic processor, the emulsion is heat treated to a temperature of from about 160° F. to about 185° F. as a preheating step. Using the indirect steam heaters, subjected to ultra high temperature treatment in the range of from about 280 to about 300° F., the emulsion is held for a period of from about 5 to about 15 seconds. Next, the emulsion goes through a final homogenizer. In the homogenizer, the treated emulsion is then homogenized in two stages at 1000 psi and 500 psi. The aseptically heat treated emulsion is next stored in a surge tank with agitation and transferred to the aseptic filler machine where it is aseptically packaged into a 946 ml plastic bottle with a foil seal and a recloseable cap.

The aseptically packaged concentrated, nutritional liquid emulsion has an appropriate flavor and aroma when evaluated at 3, 6, 12 and 18 months after manufacture and packaging. The emulsion remains physically stable over a period of from 0 to 24 months, including from 1 to 12 months.

What is claimed is:

1. An aseptically packaged composition for infants comprising an aseptically sterilized container and at least 236 ml of a sterilized, concentrated, nutritional liquid emulsion that is aseptically packaged within the container.

2. The aseptically packaged composition of claim 1 wherein the concentrated, nutritional liquid emulsion has a total solids content of from about 1.5 to about 3.5 times that of the nutritional beverage prepared as directed.

3. The aseptically packaged composition of claim 1 wherein the concentrated, nutritional liquid emulsion has a caloric density of from about 1.2 to about 4.0 kcal per ml.

4. The aseptically packaged composition of claim 1 wherein the container comprises from about 590 ml to about 1,200 ml of the concentrated, nutritional liquid emulsion.

5. The aseptically packaged composition of claim 1 wherein the container comprises from about 50% to 100% by weight of a plastic.

6. The aseptically packaged composition of claim 5 wherein the container is a flexible pouch and wherein at least 946 ml of the sterilized, concentrated, nutritional liquid emulsion is aseptically packaged within the container.

7. The aseptically packaged composition of claim 1 wherein the concentrated, nutritional liquid emulsion is hermetically sealed within the container.

8. The aseptically packaged composition of claim 1 wherein the concentrated, nutritional liquid emulsion, when subjected to centrifugation at 31,000×g, 20° C., for 8 hours, has a cream later that represents at least 7% by weight of the concentrated, nutritional liquid emulsion.

9. The aseptically packaged composition of claim 1 wherein the concentrated, nutritional liquid emulsion comprises fat, protein, and carbohydrate.

10. A method of making an aseptically packaged, concentrated, nutritional liquid emulsion for an infant, comprising the steps of:
sterilizing a concentrated, nutritional liquid emulsion;
sterilizing a container; and
aseptically packaging at least 236 ml of the sterilized emulsion into the sterilized container to form an aseptically packaged, concentrated, nutritional liquid emulsion.

11. The method of claim 10 wherein the concentrated, nutritional liquid emulsion has a total solids content of from about 1.5 to about 3.5 times that of the nutritional beverage prepared as directed.

12. The method of claim 10 wherein the concentrated, nutritional liquid emulsion has a caloric density of from about 1.2 to about 4.0 kcal per ml.

13. The method of claim 10 wherein the container comprises from about 590 ml to about 1,200 ml of the concentrated, nutritional liquid emulsion.

14. The method of claim 10 wherein the container comprises a peroxide or acid-treated internal surface.

15. The method of claim 10 wherein the container comprises from about 50% to 100% by weight of a plastic.

16. The method of claim 10 wherein the aseptically packaged, concentrated, nutritional liquid emulsion has a headspace of less than 10 cubic centimeters.

17. A method of making a liquid nutritional beverage suitable for oral administration to an infant, the method comprising the steps of:
obtaining at least 236 ml of an aseptically packaged, concentrated, nutritional liquid emulsion having a caloric density of from about 1.2 to about 4.0 kcal per ml;
decanting a portion of the concentrated, nutritional liquid emulsion into a container; and
diluting the portion with an aqueous liquid to reduce the caloric density by at least 40%, to form a liquid nutritional beverage suitable for oral administration to the infant.
